(19) United States
(12) Patent Application Publication
(10) Pub. No.: US 2005/0267964 A1
(43) Pub. Date: Dec. 1, 2005

(54) Method for providing apparatus specific information and corresponding system

(76) Inventors: Guenter Kech, Wolfach (DE); Thomas Gros, Neustadt/Westerwald (DE)

Correspondence Address: FAY KAPLUN & MARCIN, LLP, 15O BROADWAY, SUITE 702, NEW YORK, NY, 10038, US

(21) Appl. No.: 11/108,592

(22) Filed: Apr. 18, 2005

Related U.S. Application Data
(60) Provisional application No. 60/566,033, filed on Apr. 28, 2004.

(51) Int. Cl. G06F 15/173

(52) U.S. Cl. 709/223

(57) ABSTRACT

The present invention refers to a method for providing apparatus specific information for at least one field apparatus. The one field apparatus is connected via a bus to a management device managing apparatuses connected thereto, whereby the management device accesses a link network, from which the management device retrieves the apparatus specific information, whereby the management device requests the apparatus specific information autonomously from the link network and installs the retrieved apparatus specific information autonomously into its system. Further, a system is provided, comprising a management device, a field apparatus, and an access to a link network, whereby the management device is connected to the field apparatus via a bus, and is adapted to autonomously request apparatus specific information over the link network and to autonomously install the retrieved apparatus specific information into its system.

### PRIORITY CLAIM

This application claims the benefit of U.S. Provisional Patent Application Ser. No. 60/566,033 filed on Apr. 28, 2004 which is expressly incorporated herein, in its entirety, by reference.

### TECHNICAL FIELD OF THE INVENTION

The present invention relates to a method for providing updated apparatus specific information and a corresponding system comprising a management device, a field apparatus, and an access to a link network.

### BACKGROUND OF THE INVENTION

After a field apparatus like a sensor or an actuator is finished, it is known from prior art to determine characteristics of a the field apparatus, as for example serial number, manufacturing data, linearity parameters, measuring range, operative range with respect to temperature, electrical characteristics (operating voltage, connection power, output characteristics, etc.) manually or by means of an automat. After manually determining these data, they are available for a user together with operating instructions, technical manual, approval documents, reliability statements, and so on either on paper or as electronic document.

The electronic document could also be obtained by the user via the internet. For this, the user had to search on a web page of the manufacturer for the apparatus type. If he found the right apparatus type, the desired documents, data or software could be downloaded from the web page or sent by email.

To store all these documents, cost-intensive archives were needed. The user himself had to have a substantial organizational system, guaranteeing, if need be, recovering and making the documents available in reasonable time.

The effort was less in case the user had a system stored on a CD-ROM or hard disc. However, even in the case of a networked process control system, he needed to carry out a manual assignment of the document file and the measuring unit (TAG no.). This also resulted in time and cost expenditure, and even possible input errors.

During updating of products (software update, apparatus upgrade, repair, maintenance, etc.) the search via the internet can be problematic, especially due to possible new apparatus or software versions. The new assignment, thus, also has to be carried out manually involving all the already mentioned risks.

### SUMMARY OF THE INVENTION

Implementations of the invention can include one or more of the following features.

According to an aspect of the present invention, a method for providing apparatus specific information for at least one field apparatus is provided, whereby the field apparatus is connected via a bus to a management device managing apparatuses connected thereto, whereby the management device accesses a link network, from which the management device retrieves the apparatus specific information, whereby the management device requests the apparatus specific information autonomously from the link network and installs the retrieved apparatus specific information autonomously into its system.

According to another aspect of the invention, for autonomous request of the apparatus specific information of the at least one field apparatus, the management device queries the apparatus identification number, the firmware version, and the address of a web server, which comprises the apparatus specific information. The apparatus specific information is retrieved from the link network, in particular the internet, comprising a server, a page generator, and a data base.

Further, the management device accesses an apparatus type data base for transmitting apparatus specific information of a field apparatus selected by the management device and connected thereto.

According to yet another aspect of the present invention, the management device accesses a customer data base for transmitting specific data of a special customer selected by the management device. The management device accesses a service data base.

According to a further aspect, the field apparatus is a measuring unit. Particularly, the field apparatus may be realized as a fill level measuring unit for measuring a fill level, for instance of a liquid in a tank, or may be realized as a pressure measuring unit. The management device comprises a PC with a process control unit or a device type manager (DTM). Moreover, the management device occasions autonomously an update of the field apparatus software.

According to still a further aspect of the present invention, the management device queries the apparatus identification number of the at least one field apparatus, which is stored in or at the field apparatus in electronic, electromechanical, or in optical form.

The management device reads-out the apparatus identification number of the at least one field apparatus via the bus, a serial interface, a parallel interface, an optical scanner or electromechanically. Moreover, the management device reads the apparatus identification number of the field apparatus automatically or by means of specific software into its memory and subsequently formulates the request to the link network.

One more aspect of the invention is that the management device formulates the request as WEB page request, which is directed to a WEB server, an FTP server or a special service of the manufacturer of the at least one field apparatus. For requesting the apparatus specific information via the link network, an access authorization of the management device is inquired.

Method according to claim 1, whereby the management device requests a technical manual, operating instructions, or approval documents as apparatus specific information.

Still another aspect of the present invention is that the management device requests software updates and upgrades for the field apparatus as apparatus specific information directly from the manufacturer via the internet. The management device requests apparatus specific information from a customer owned info data base, into which a user can input additional information.

According to still another aspect of the present invention, a user contacts the support of the manufacturer via the management device and the link network, to request apparatus specific information.

According to an aspect of the present invention, a method for providing apparatus specific information for at least one field apparatus is provided, which is connected via a bus to a management device managing apparatuses connected thereto, whereby the management device accesses a link network, from which the management device retrieves the apparatus specific information, whereby the management device requests the apparatus specific information autonomously from the link network and installs the retrieved apparatus specific information autonomously into its system, whereby for autonomous request of the apparatus specific information of the at least one field apparatus, the management device queries the apparatus identification number, the firmware version, and the address of a web server, which comprises the apparatus specific information, whereby the management device further occasions autonomously an update of the field apparatus software.

According to another aspect of the present invention, a system, comprising a management device, a field apparatus, and an access to a link network is provided, whereby the management device is connected to the field apparatus via a bus, and is adapted to autonomously request apparatus specific information over the link network and to autonomously install the retrieved apparatus specific information into its system.

Another aspect of the present invention is that the management device is adapted to query the apparatus identification number, the firmware version, and the address of a web server, which comprises the apparatus specific information to autonomously request the apparatus specific information.

Still a further aspect of the present invention is that the management device is connectable to the link network, in particular the internet, comprising a server, a page generator, and a data base. Moreover, the management device is adapted to access an apparatus type data base for transmitting apparatus specific information of a selected field apparatus. The management device is adapted to access a customer data base for transmitting specific data of a special customer selected by the management device.

Moreover, the management device is adapted to access a service data base. According to another aspect of the present invention, the field apparatus is a measuring unit. The management device comprises a PC or a device type manager (DTM).

According to still another aspect of the present invention, the management device is adapted to autonomously occasion an update of the field apparatus software.

Further, an apparatus identification number of the at least one field apparatus is stored in or at the field apparatus in electronic, electromechanical, or in optical form. The management device is adapted to read-out the apparatus identification number of the at least one field apparatus via the bus, a serial interface, a parallel interface, an optical scanner or electromechanically.

Yet one more aspect of the present invention is that the management device is adapted to read the apparatus identification number of the field apparatus automatically or by means of specific software into its memory and subsequently to formulate the request to the link network.

Still a further aspect of the invention is that the management device is adapted to formulate the request as WEB page request, which is directed to a WEB server, an FTP server or a special service of the manufacturer of the at least one field apparatus.

Moreover, according to another aspect of the present invention, the management device is adapted to request software updates and upgrades for the field apparatus as apparatus specific information directly from the manufacturer via the internet.

According to one more aspect of the present invention, the management device is adapted to request apparatus specific information from a customer owned info data base, into which a user can input additional information. Moreover, the management device is integrated into a customer documentation system.

According to an aspect of the present invention, a system is provided, comprising a management device, a field apparatus, and an access to a link network whereby the management device is connected to the field apparatus via a bus and is adapted to autonomously request apparatus specific information over the link network and to autonomously install the retrieved apparatus specific information into its system., whereby the management device is connectable to the link network, in particular the internet, comprising a server, a page generator, and a data base, whereby the management device further is adapted to request software updates and upgrades for the field apparatus as apparatus specific information directly from the manufacturer via the internet, and whereby the management devices adapted to query the apparatus identification number, the firmware version, and the address of a web server, which comprises the apparatus specific information to autonomously request the apparatus specific information.

### BRIEF DESCRIPTION OF THE DRAWINGS

FIG. 1 is a schematic diagram of a documentation system according to prior art;

FIG. 2 is a schematic diagram of an electronic documentation system according to prior art;

FIG. 3 is a schematic diagram of the system according to the present invention;

FIG. 4 is a schematic diagram of the system according to the present invention;

FIG. 5 is a screenshot showing apparatus specific information;

FIG. 6 is a screenshot showing apparatus specific information retrievable by the manufacturer's homepage via the internet.

### DETAILED DESCRIPTION OF EXEMPLARY EMBODIMENTS OF THE PRESENT INVENTION

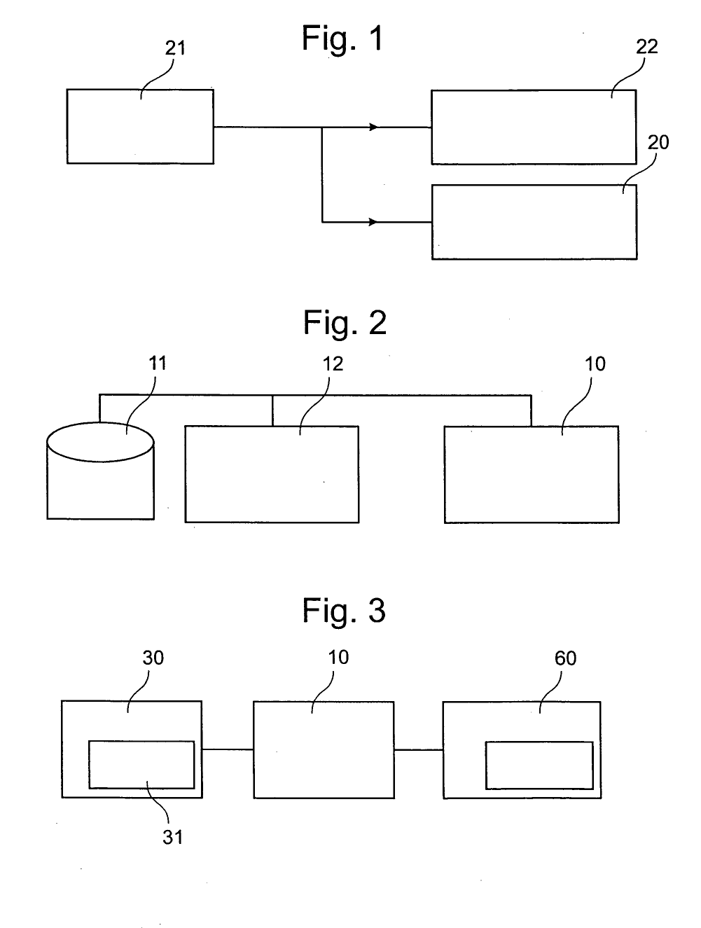

According to FIG. 1, a schematic diagram of a documentation system known from prior art is shown. After the apparatus 21 is completed, operating instructions are either added as paper documents 22 or can be downloaded from the internet 20 as electronic document, e.g. in form of a PDF file, after searching the internet for the correct apparatus type. For searching the internet 20, however, the user had to search for the apparatus type on the web page of the manufacturer and had to download the electronic documents, data or software from the internet.

Also other characteristics of a the finished field apparatus 21 which can be a sensor or an actuator, like serial number, manufacturing data, linearity parameters, measuring range, operative range with respect to temperature, electrical characteristics (operating voltage, connection power, output characteristics, etc.) can be determined according to prior art manually, using the paper documents 22, or by searching the internet.

In FIG. 2 another schematic diagram of a documentation system according to prior art is shown. This is an alternative to a paper archive. The system comprises a PC 12, a process control system 10, and a CD ROM or hard disc 11 connected to each other. The CD-ROM or hard disc 11 is employed for storing product specific data and documents. Also using this networked documentation system, the user has to assign the document file to a measuring unit (TAG no.) manually, bearing the risk of input errors. Also searching the internet for software updates, apparatus upgrades, and so on has to be carried out manually with this arrangement according to prior art.

FIG. 3 is a schematic diagram showing the inventive system. A field apparatus 30, like a sensor or actuator, is connected to a process control system comprising a management device 10 managing the apparatuses connected thereto. The field apparatus 30 and the management device are connected to each other via a bus, like for example a field bus. The management device 10 can be a server with corresponding software tolls, like a device type manager or it can also be a PC having an access to the internet 60. The management device 10 can be integrated into a customer documentation system. Using the apparatus identification number, the management device 10 autonomously requests the operating manual, new firmware, factory settings, user instructions, QS documents etc. from a web server 60 comprising a product data base containing the necessary information and installs the retrieved data or software autonomously into its system.

The management device is also capable of autonomously occasioning an update of the field apparatus software. To fulfill these comprehensive tasks, the management device 10 needs the following information, which he obtains from the field apparatus 30 via the field bus: the product information number, the firmware version, and the address of the web server 60, on which the documents are stored.

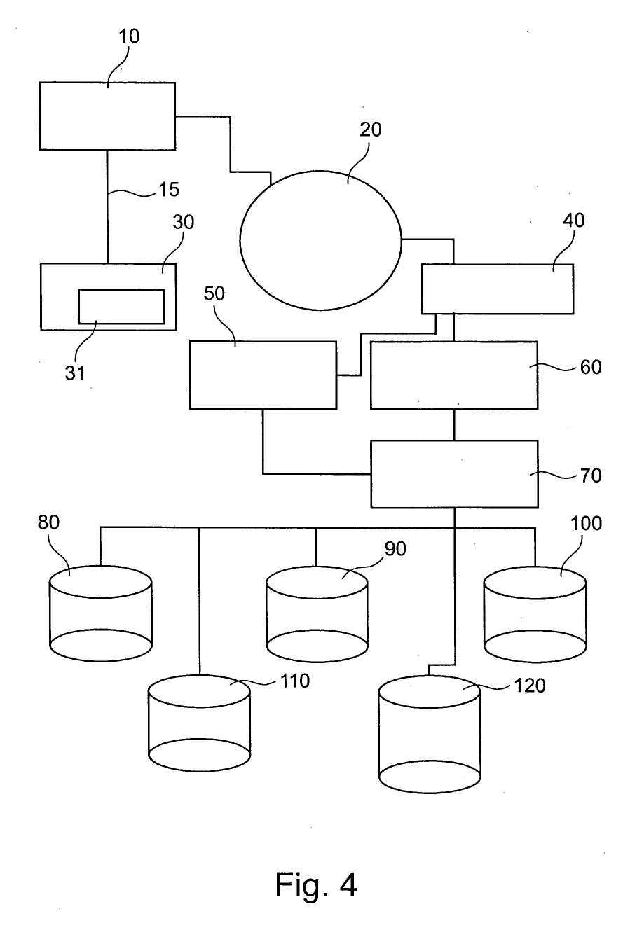

According to FIG. 4, showing a schematic diagram of the inventive system, it is possible for a user to obtain information like product description, operating manual, QS documents, service information and so on concerning a specific field apparatus 30 by means of a process control system or PC comprising the management device 10. An identification number is stored on or in the field apparatus in electronic, electromechanical, or in optical form, which is transmitted by the PC comprising the management device 10 to the link network 20 or internet. The PC comprising the management device 10 and the field apparatus 30 are connected to each other via a bus 15, like field bus, Ethernet, Bluetooth or WLAN, serial or parallel interfaces, optical scanners, etc.

The apparatus identification number 31 contains the manufacturer identification, the apparatus type identification, an unambiguous serial number, as well as the software firmware version of the apparatus. The management device 10 can read either automatically or upon request of a user the apparatus information into its memory, e.g. by means of the device type manager, and form this information, formulate a request towards the link network 20. This request can be formulated as WEB page request (https://www.vega.com/ProduktSearch.aspx?language=de&vendor=b208&produkt=252&seri al=11688303&firmware=1.2.3). This request is directed via the internet 20 to the WEB server, FTP server or a special service of the manufacturer. By means of the information transmitted to the URL, the page generator program 70 is enabled to determine information with respect to the apparatus 30. This can result by the command in an SQL driver “select* from productTyp.DB where (Vendor=b208) and (product=252)”). Then a web page can be sent via the internet 20 to the process control system or PC containing the management device 10.

Additionally, to protect customer specific information, an access authorization 40 can be provided. By this it is guaranteed that customer data are not accessible for third parties.

The data transmitted in this manner can be apparatus specific information like apparatus description, operating manual or approval documents. However, also advanced information can also be provided as factory settings, repair documentation, or service, operating data, and so on. All these data and information is stored in data bases 80, 90, 100, 110, 120 in the internet 20. The types of data bases are: customer data base 80, apparatus type data base 90, apparatus data base 100, service data base 110, customer owned info data base 120.

The user can retrieve safety instructions with respect to the previous apparatus—hardware and software status, callbacks or firmware updates recommended by the manufacturer from the service data base 119 and/or from the apparatus data base 90. Software updates and add-ons can also be transmitted directly from the manufacturer via the internet to the PC comprising the management device 10. As far as a direct connection to the apparatus exists, this software can also be transmitted immediately to the field apparatus.

The customer owned info data base 120 is adapted for the customer to input his own additional information, like for example installation locality, maintenance intervals, as well as own comments. By this, a central information data base including al necessary information with respect to the apparatus is established.

The system further is adapted for the user to directly contact the manufacturer's support via the internet 20 from his PC comprising the management device 10 by means of email or web page request. The user will then obtain assistance via the internet or the phone directly during setup of the apparatus.

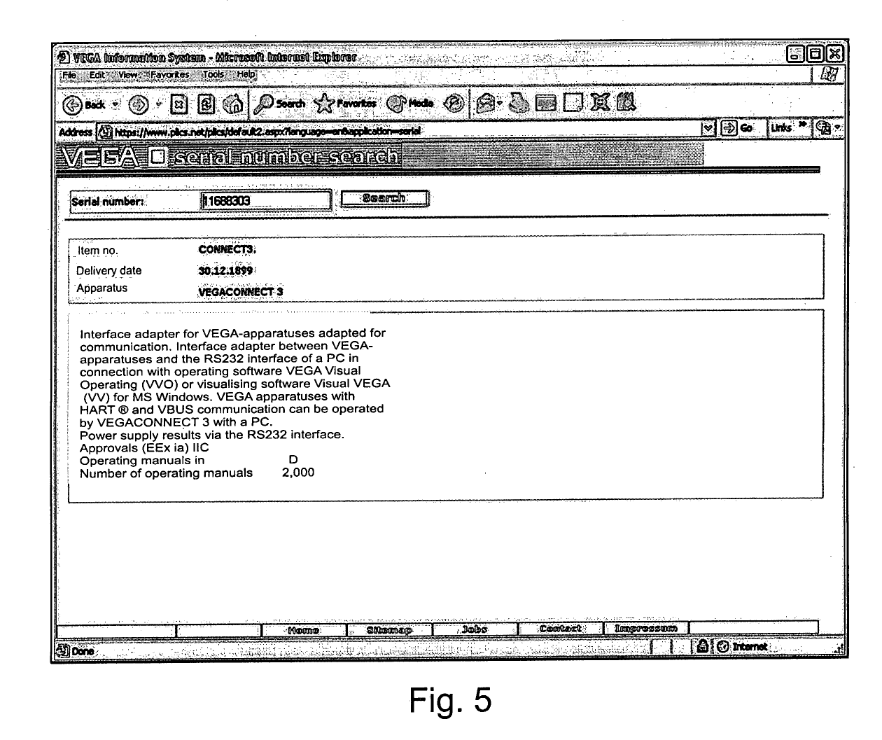

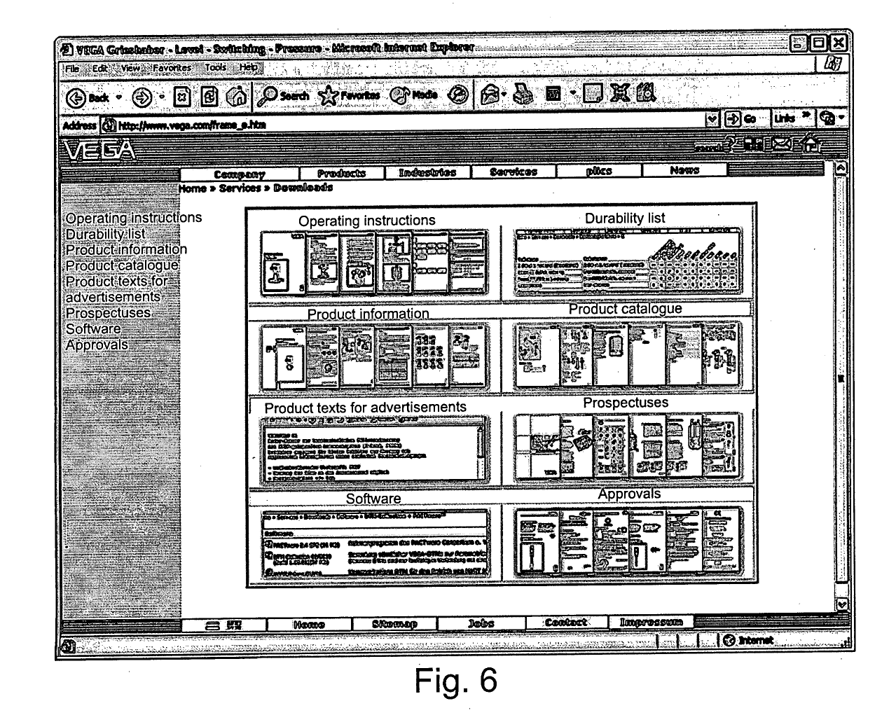

FIG. 5 shows a screenshot of one of the simplest forms of apparatus specific information retrieved from the internet. In this case, an apparatus description was requested and is displayed on a screen connected to the PC comprising the management device 10. According to FIG. 6, apparatus specific information can be chosen from a variety of information like: operating manual, durability list, product information, product catalogue, product text for advertisements, prospectuses, repair form, software, authorizations.

Other embodiments of the invention are within the scope of the attached claims.

1. A method for providing apparatus specific information for at least one field apparatus, which is connected via a bus to a management device, wherein the management device manages apparatuses connected thereto, wherein the at least one field apparatus is a measuring unit, the method comprising the following steps:
accessing a link network by means of the management device, from which network the management device retrieves the apparatus specific information,
requesting apparatus specific information autonomously from the link network by means of the management device, and
installing the retrieved apparatus specific information autonomously into its system by means of the management device.

2. The method according to claim 1, whereby for autonomous request of the apparatus specific information of the at least one field apparatus, the management device queries the apparatus information number, the firmware version, and the address of a web server, which comprises the apparatus specific information.

3. The method according to claim 1, whereby the management device retrieves the apparatus specific information from the link network, in particular the internet, comprising a server, a page generator, and a data base.

4. The method according to claim 1, whereby the management device accesses an apparatus type data base for transmitting apparatus specific information of a field apparatus selected by the management device and connected thereto.

5. The method according to claim 1, whereby the management device accesses a customer data base for transmitting specific data of a special customer selected by the management device.

6. The method according to claim 1, whereby the management device accesses a service data base.

7. The method according to claim 1, whereby the management device comprises a PC or a device type manager.

8. The method according to claim 1, whereby the management device occasions autonomously an update of the field apparatus software.

9. The method according to claim 2, whereby the management device queries the apparatus identification number of the at least one field apparatus, which is stored in or at the field apparatus in electronic, electromechanical, or in optical form.

10. The method according to claim 1, whereby the management device reads-out the apparatus identification number of the at least one field apparatus via the bus, a serial interface, a parallel interface, an optical scanner or electromechanically.

11. The method according to claim 1, whereby the management device reads the apparatus identification number of the field apparatus automatically or by means of specific software into its memory and subsequently formulates the request to the link network.

12. The method according to claim 1, whereby the management device formulates the request as WEB page request, which is directed to a WEB server, an FTP server or a special service of the manufacturer of the at least one field apparatus.

13. The method according to claim 1, whereby for requesting the apparatus specific information via the link network, an access authorization of the management device is inquired.

14. The method according to claim 1, whereby the management device requests a technical manual, operating instructions or approval documents as apparatus specific information.

15. The method according to claim 3, whereby the management device requests software updates and upgrades for the field apparatus as apparatus specific information directly from the manufacturer via the internet.

16. The method according to claim 1, whereby the management device requests apparatus specific information from a customer owned info data base, into which a user can input additional information.

17. The method according to claim 1, whereby a user contacts the support of the manufacturer via the management device and the link network, to request apparatus specific information.

18. The method according to claim 1, whereby for autonomous request of the apparatus specific information of the at least one field apparatus, the management device queries the apparatus identification number, the firmware version, and the address of a web server, which comprises the apparatus specific information, and
the management device further occasions autonomously an update of the field apparatus software.

19. A system, comprising
a management device,
a field apparatus, and
an access to a link network,
whereby the management device is connected to the field apparatus via a bus, and is adapted to autonomously request apparatus specific information over the link network and to autonomously install the retrieved apparatus specific information into its system,
whereby the field apparatus is a measuring unit.

20. The system according to claim 19, whereby the management device is adapted to query the apparatus identification number, the firmware version, and the address of a web server, which comprises the apparatus specific information to autonomously request the apparatus specific information.

21. The system according to claim 19, whereby the management device is connectable to the link network, in particular the internet, comprising a server, a page generator, and a data base.

22. The system according to claim 19, whereby the management device is adapted to access an apparatus type data base for transmitting apparatus specific information of a selected field apparatus.

23. The system according to claim 19, whereby the management device is adapted to access a customer data base for transmitting specific data of a special customer selected by the management device.

24. The system according to claim 19, whereby the management device is adapted to access a service data base.

25. The system according to claim 19, whereby the management device comprises a PC or a device type manager.

26. The system according to claim 19, whereby the management device is adapted to autonomously occasion an update of the field apparatus software.

27. The system according to claim 19, whereby an apparatus identification number of the at least one field apparatus is stored in or at the field apparatus in electronic, electromechanical, or in optical form.

28. The system according to claim 19, whereby the management device is adapted to read-out the apparatus identification number of the at least one field apparatus via the bus, a serial interface, a parallel interface, an optical scanner or electromechanically.

29. The system according to claim 19, whereby the management device is adapted to read the apparatus identification number of the field apparatus automatically or by means of specific software into its memory and to subsequently formulate the request to the link network.

30. The system according to claim 19, whereby the management device is adapted to formulate the request as WEB page request, which is directed to a WEB server, an FTP server or a special service of the manufacturer of the at least one field apparatus.

31. The system according to claim 21, whereby the management device is adapted to request software updates and upgrades for the field apparatus as apparatus specific information directly from the manufacturer via the internet.

32. The system according to claim 19, whereby the management device is adapted to request apparatus specific information from a customer owned info data base, into which a user can input additional information.

33. The system according to claim 19, whereby the management device is integrated into a customer documentation system.

34. The system according to claim 19, whereby the management device is connectable to the link network, in particular the internet, comprising a server, a page generator, and a data base, whereby the management device further is adapted to request software updates and upgrades for the field apparatus as apparatus specific information directly from the manufacturer via the internet, and whereby the management device is adapted to query the apparatus identification number, the firmware version, and the address of a web server, which comprises the apparatus specific information to autonomously request the apparatus specific information.
